(19) United States
(12) Patent Application Publication
(10) Pub. No.: US 2012/0304472 A1
(43) Pub. Date: Dec. 6, 2012

(54) MULTI-ANGLE HAND HELD CUTTING TOOL

(76) Inventor: Simon Medhurst, Burlington, CA (US)

(21) Appl. No.: 13/487,330

(22) Filed: Jun. 4, 2012

Related U.S. Application Data
(60) Provisional application No. 61/492,676, filed on Jun. 2, 2011.

(51) Int. Cl. B26B 1/04; B26B 1/08

(52) U.S. Cl. 30/162; 30/321

(57) ABSTRACT

A hand tool for use with a cutting blade having two parallel cutting edges provides for selective locking of a handle portion relative to a tool holding portion in two positions which are mirror images of each other, thereby allowing for use of both opposed parallel cutting edges of the cutting blade without the need for removal and re-positioning of the cutting blade in the tool holding portion.

### FIELD OF THE INVENTION

The present invention relates generally to the field of hand tools, and more particularly to those having a tool holding portion that is adjustable relative to a handle portion to at least two operating positions.

### BACKGROUND OF THE INVENTION

The field of hand held tools is one in which various previously known types of hand tools may have a tool holding portion that is selectively configured to be operated at multiple positions relative to the handle portion of the hand tool. The tool holding portion typically has a major longitudinal axis along which the tool positioned therein longitudinally extends (hereinafter, sometimes referred to as the “tool axis”), and the handle portion also typically has a major longitudinal axis around which the handle portion longitudinally extends for gripping by a user (hereinafter, sometimes referred to as the “handle axis”). The tool axis may be arranged to run parallel with the handle axis, such as, for example, with a conventional screwdriver, or the two longitudinal axis may be angled to one another, as for example, in a conventional ratchet device. More recently, hand tools permitting adjustment of the tool angle to the handle angle have become popular, as they offer more flexibility and convenience (and sometimes allow greater torque to be applied to a workpiece) to users in a wide variety of work situations. For example, screw drivers or ratchets are known to have multiple operating positions such that, depending upon the orientation of the tool axis relative to the handle axis, the tool element may selectively engage a workpiece with the tool axis in generally parallel relation to the handle axis, or with the tool axis perpendicular to the handle axis. Moreover, in some of these adjustable hand tools, the angle between the tool axis and the handle axis may be varied to any intermediate angle selected by the user. The particular angle of inclination between the two aforementioned major longitudinal axis will typically be dictated by the potential utility of the screwdriver or ratchet at those orientations.

Further, many prior art hand tools are known to have interchangeable tool elements. For example, screw drivers are known to accommodate interchangeable screw driver bits for accommodating screw driving heads having different patterns. Notwithstanding this, most utility knives provide for the use of but a single type of cutting blade, typically being the standard quadrilateral-shaped utility blades that have upper and lower parallel edges, the lower edge of which is typically sharpened and of generally longer length than the upper edge, with the upper edge typically being unsharpened and having one or more notches designed to index with a holding means positioned in the tool holding portion of the utility knife. The other two edges are also typically unsharpened, and are generally shorter and angled congruently, but in opposite directions, angled away from one another to provide for a reversible blade having two points at opposite ends of the longer, lower cutting edge of the blade.

Most utility knives provide for replacement of a blade when it becomes dull or broken, and some utility knives even provide for interchangeability of the standard utility cutting blades with blades having different profiles. For example, a standard utility cutting blade may be replaced with a hooked blade for cutting linoleum or the like. Typically, however, the length and style of blades that can be interchanged with the handle portions of known utility knives are somewhat limited, with all being of the same general thickness, length and shank profile, as such shank portion must be accepted by and held fast within the blade holding means associated with the handle portion of the knife. In other words, the means for releasably holding the cutting blade by its shank portion is typically static in the prior art, in the sense that such means is only capable of accommodating one particular profile and thickness of blade shank. Similarly, known screw driver handle portions accommodating interchangeable tool elements (in the form of screw driver bits) will (in the absence of having an adjustable chuck mechanism), only accept screw driver bits of a shank single cross-sectional profile. Such a design is particularly limiting when one considers that limiting the length and/or thickness of the shank portion of a tool element will also place significant limitations on the overall length and size of the tool element that can be successfully anchored and supported thereby.

Another manner of providing different tool elements in association with a single hand tool takes the form of the well-known Swiss Army Knife™, available from, for example, Wenger S. A., of Delemont, Switzerland, which may have several tool elements associated with a single knife or tool handle portion. These tool elements may take many forms in addition to screw driver bits, sawing blades or cutting blades, including, for example and without limitation, corkscrews, can openers, scissors, magnifying glasses, cutlery items namely, forks, spoons, knives and the like. The term “tool element” is used herein to have an equally broad scope of coverage. Nonetheless, the Swiss Army Knife™ solution for providing different tool elements in association with a single hand tool does not truly embody interchangeable tool elements within the meaning of the word interchangeable because the tool elements included in a Swiss Army Knife™ are generally permanently affixed to the body or handle portion.

Use of hand tools having a cutting blade comprising a single cutting edge is inefficient with respect to time and/or cost. For such hand tools having interchangeability of cutting blades, the user must replace the cutting blade (i.e., the tool element) when the single cutting-edge becomes dull. Such replacement of dull cutting blades requires the user to spend valuable time replacing the blade; the replacement of dull single edge cutting blades also requires users to purchase and use twice as many replacement cutting blades for a particular job.

Use of hand tools having a cutting blade comprising two cutting edges in opposed parallel relation to each other is ineffective and/or inefficient because when one of the cutting edges becomes dull, the user may be forced to waste valuable time associated with removing the cutting blade from the tool holding portion and repositioning the cutting blade therein so as to allow for the non-dull cutting edge to be in a proper orientation for engagement with a workpiece in the field of use. Alternatively, when a cutting edge becomes dull, the user may rotate the hand tool around the handle axis by 180° to reposition the hand tool relative to the field of use such that the non-dull cutting edge is in position to engage the field of use. However, such use of hand tools may be ineffective or unsafe, depending on the positioning of the tool axis relative to the handle axis. For example, with respect to hand tools having a tool axis parallel to the handle axis (i.e., having the tool axis forming a 180° angle with the handle portion longitudinal axis), it is well known that cutting a surface using a cutting blade that extends outwardly from the tool holding portion along the tool axis may be suboptimal. It has been determined that it is more effective to position the tool axis along which a cutting blade extends in such a way that the tool axis forms an ergonomically correct angle with the handle axis, with said angle being between approximately 35° and 50°. With respect to hand tools having a tool axis fixed in a position relative to the handle axis such that the angle formed between the two axes is between about 35° and about 50° degrees, the use of a double edged cutting blade is only effective in one orientation—i.e. along one of the two opposed parallel cutting edges. For such hand tools, if the user were to rotate the hand tool around the handle axis by 180° in an attempt to use the other parallel, opposed cutting edge, the tool axis portion would be positioned so as to form a 215°-230° with the handle axis. Use of the cutting edge in such an orientation is both ineffective and extremely unsafe. Accordingly, for those hand tools having a tool axis fixed in relation to the handle portion longitudinal axis, the user is forced to remove the double edge cutting blade from the tool holding portion after each cutting edge becomes dull, thereby making such hand tools extremely inefficient for industrial/commercial purposes.

U.S. patent application Ser. No. 12/391,557, filed Feb. 24, 2009, having Publication No. 2009/0217536 (hereinafter, “Medhurst”), discloses a utility knife having a tool holding portion which accommodates interchangeable tool elements. More specifically, Medhurst discloses a tool holding portion that has a mechanism for releasably holding cutting blades or saw blades of different lengths, based upon using a novel shank design for the interchangeable blades. The handle portion of the Medhurst hand tool is also adjustable with respect to the tool holding, so as to provide for selective adjustment of the angle of the tool axis and the handle axis, so as to allow for efficient and ergonomic comfort in use. As such, Medhurst provides for adjustable rotation of the tool axis relative to the handle axis. Significantly, however, this relative rotation is limited to 90° of rotation, or less. This, in turn, significantly limits the utility of the Medhurst hand tool, as it prevents the disclosed device from being usable with double sided tool elements having substantially opposed parallel upper and lower active edges (e.g., cutting or sawing blades having sharpened parallel upper and lower edges), as the upper edge of the blade cannot be placed for use in the same ergonomically acceptable position as was the lower edge of the blade without first removing it from the tool holding portion, and thereafter flipping it through 180° of rotation before replacement in the tool holding portion. However, such replacement in inverted relation within the tool holding portion is not possible with the Medhurst device, as the tool holding portion of Medhurst will not operatively hold any of the blades disclosed in such a usable, inverted configuration.

There thus exists in the prior art the need for a hand tool which allows not only for relative selective adjustment of the tool axis relative to the handle axis, but also provides for the use of double sided tool elements having opposed, parallel upper and lower edges, without the need to remove the tool element from the tool holding portion. Such double sided tool elements are commonly used by tradespersons involved in extensive cutting operations, such as, for example by carpet installers, who typically prefer using double edged cutting blades in their carpet cutting knives. However, such prior art carpet cutting knives typically have a fixed angle of inclination of the tool axis relative to the handle axis, which fixation requires the aforesaid removal of double edged cutting blades from the tool holding portion before being repositioned therein for use of the second edge of the cutting blade. This wastes considerable time for the installer over the course of a work day where a significant plurality of such blade changes will typically be needed to complete a single carpet installation.

It is thus an object of this invention to obviate or mitigate at least one of the above mentioned disadvantages and other shortcomings of the prior art by providing a hand tool that allows for sequential usage of both edges of double sided tool elements, such as cutting or saw blades, in an ergonomically friendly and efficient manner, while obviating the need to remove the tool element from the tool holding portion in order to achieve such double edge tool element usage.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

FIG. 1A is a top perspective view of a hand tool, being a utility knife, according to an exemplary embodiment of the invention, with the cutting blade thereof illustrated in a fully retracted storage configuration;

FIG. 1B is view similar to FIG. 1B, but with the cutting blade thereof illustrated in an extended in-use blade configuration;

FIG. 2A is a perspective view of the utility knife of FIG. 1A, taken from the opposite direction of FIG. 1A, with components of the handle portion and of the tool holding portion removed for ease of illustration and the cutting blade thereof illustrated in a fully retracted configuration;

FIG. 2B is a view similar to FIG. 2B, but with cutting blade thereof illustrated in a fully extended configuration;

FIG. 2C is a partly exploded, top elevational view of the utility knife of FIG. 2B;

FIG. 3A is a view similar to FIG. 1A, with components of the handle portion and of the tool holding portion removed for ease of illustration and the cutting blade thereof illustrated in a fully retracted configuration;

FIG. 3B is a view similar to FIG. 2C, but with all of the components of the utility knife shown fully exploded;

FIG. 4 is an sectional view along line 4-4 of FIG. 2A; and,

FIG. 5 is a sectional view along line 5-5 of FIG. 2B.

### DETAILED DESCRIPTION OF AN EXEMPLARY EMBODIMENT

For brevity and ease of illustration, the present invention will now be described in detail in relation to but a single exemplary embodiment that utilizes a double edged cutting blade as the interchangeable tool element, although it will be appreciated by those skilled in the art that other double sided tool elements having both opposed, parallel upper and lower active edges may be readily substituted for the cutting blade illustrated and described hereinbelow, with only routine modifications to the components and structures of the illustrated embodiment to accommodate such a substitution.

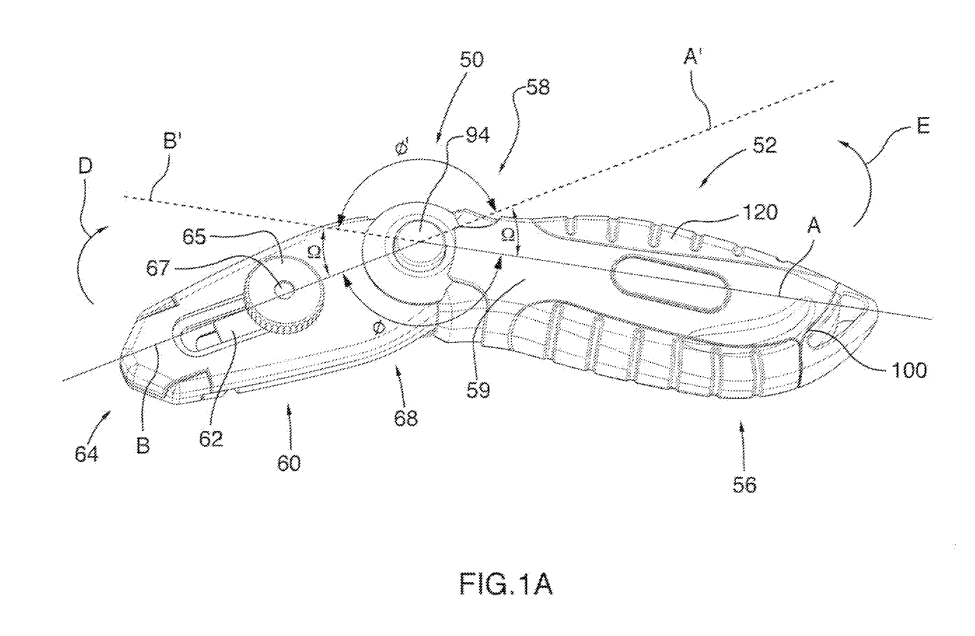

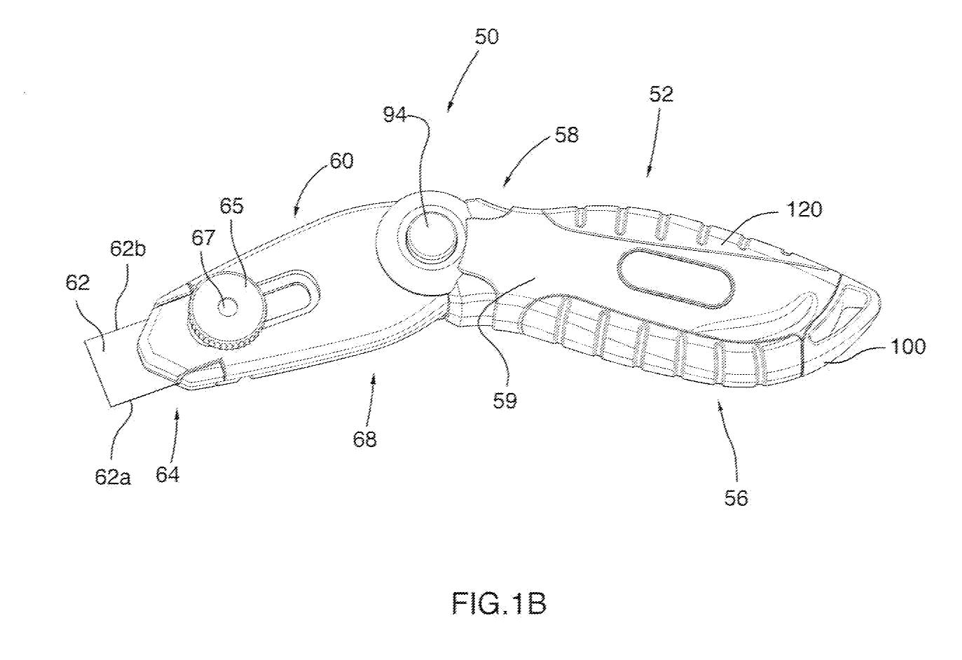

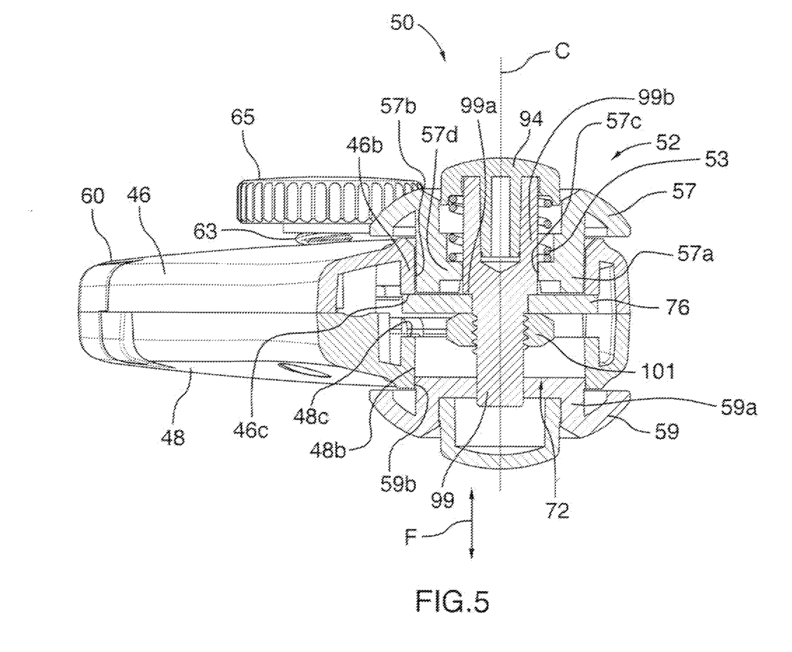

There will be seen in FIGS. 1A and 1B a hand held cutting tool 50, being a utility knife, and having a handle portion 52 that defines a longitudinal axis “A” of the handle portion (sometimes referred to hereinafter as the “handle axis”) around which a user grips the cutting tool 50 in use. The handle portion 52 has a distal end 56, a proximal end 58, and at least one locking mechanism 72 positioned adjacent the proximal end 58 (as best seen in the exploded views and in FIG. 5), between which ends the longitudinal axis A extends.

The utility knife 50 also has a tool holding portion 60 in which a tool element in the form of a cutting blade 62 is operatively mounted, which tool holding portion 60 defines a longitudinal axis “B” of the tool holding portion 60 (sometimes referred to hereinafter as the “tool axis”) parallel to which longitudinal axis “B” the cutting blade 62 being used also longitudinally extends. The cutting blade 62 illustrated in the Figures is depicted as a slotted double edged cutting blade having first 62a and second 62b cutting edges arranged in opposed, generally parallel relation to one another. The first cutting edge 62a is shown in FIG. 1B as the lower cutting edge, while the second 62b cutting edge is shown as being the upper cutting edge, although this orientation is relative, and will of course change as the utility knife 50 is rotated or viewed from different angles. The first 62a and second 62b cutting edges are preferably operatively held within the tool holding portion 60 in substantially parallel relation to the tool axis B, with an operative end portion of the cutting blade 62 extending, in use, from the distal end of the tool holding portion 60. As stated above, the tool element 62 may be another type of double-edged cutting blade from that shown, such as, for example, a saw blade or other cutting blade having teeth or serrations, and thus is not limited to the precise form shown in the figures.

As may be seen by, for example, a comparison of FIGS. 1A and 1B, the cutting blade 62 may optionally be variably extended and retracted along tool axis B into and out of the distal end 64 of the tool holding portion 60. Such a retractable design, which is fully optional, allows a user to retract the tool element 62 into the tool holding portion 60 when the cutting tool 50 is not in use, thereby protecting the tool element 62 from becoming damaged and also protecting the user from the tool element 62. FIG. 1A illustrates the tool element 62 in a retracted storage configuration, wherein the tool element 62 is retracted fully into a cavity formed within the tool holding portion 60. FIG. 1B illustrates the tool element 62 in an extended in-use blade configuration wherein, the tool element 62 is extended from the tool holding portion 60 along the tool axis B.

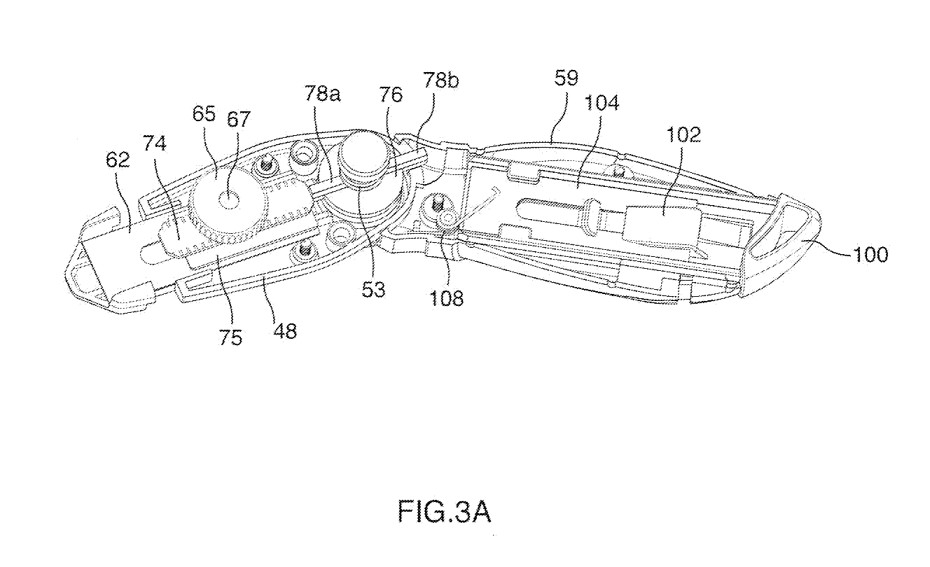

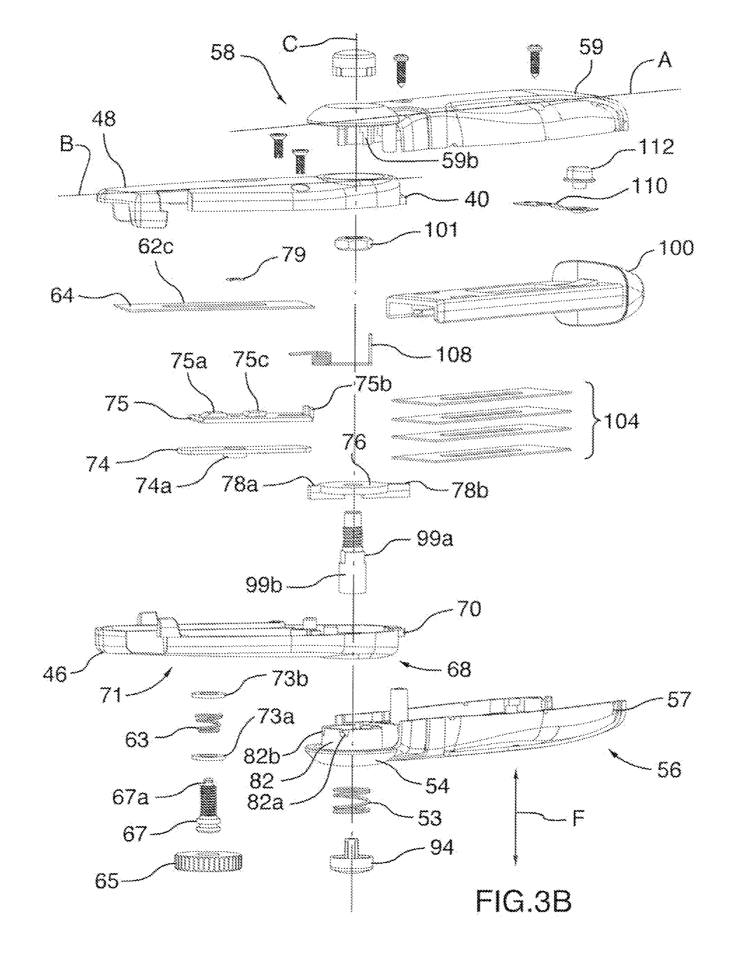

The tool holding portion 60 has a distal end 64 from which the double edged cutting blade 62 operatively extends when in its extended in-use blade configuration (as shown in FIG. 1B), thereby to engage a workpiece (not shown), which workpiece may, for example, be a piece of carpet to be cut or trimmed. The tool holding portion 60 also has a proximal end 68 that is pivotally coupled to the proximal end 58 of the handle portion 52 to permit pivotal movement of the tool holding portion 60 around a rotational axis “C” that intersects and is transverse to both the handle axis A and the tool axis B (as best seen in FIG. 3B). The tool axis B extends between the distal end 64 and the proximal end 68, as is readily apparent from the Figures. In this manner, the inclination angle “Φ” of the tool axis B relative to the handle axis A may be varied. The locking mechanism 72 is interconnected between the handle portion 52 and the tool holding portion 60 to provide for selective locking up of the handle portion relative to the tool holding portion to prevent such pivotal movement at two or more pre-defined and ergonomically advantageous angular in-use tool configurations. Where only two such pre-defined angular in-use tool configurations are desirable, as, for example, with the use of the double-edged cutting blade 62 depicted in the figures, the first of such angular in-use tool configurations is preferably set with an inclination angle between the handle axis A and the tool axis B=Φ, and with the second of such angular in-use tool configurations preferably set at an inclination angle between the handle axis and the tool axis also equal to Φ, but in an opposite rotational direction, as shown in FIG. 1A. This second in-use tool configuration is not, for the sake of simplicity, shown structurally in any of the figures, but is indicated by dotted axis lines B′ and A′ in FIG. 1A, whereat tool axis B has been rotated through angle Ω from its original in-use tool configuration in the direction of curved arrow “D” to thereafter occupy a second in-use tool configuration indicated by phantom tool axis B′, and handle axis A has been rotated through angle Ω in the direction of curved arrow “E” so as to occupy a position indicated by phantom handle axis A′, with the angle Φ′ being formed between axes A′ and B′. It will be readily appreciated that the first and second in-use configurations depicted in FIG. 1A are mirror images of one another. Such an arrangement allows a user to quickly position the hand tool 50 in the first pre-defined angular in-use tool configuration (i.e., with the orientation angle between longitudinal axis A and longitudinal axis B=Φ) which will, as illustrated in the Figures, advantageously position the first edge 62a of the cutting blade 62 in an ergonomically advantageous position for use of the first cutting edge 62a of the cutting blade 62 until it is dull, at which time the user may quickly unlock the locking mechanism 72 and reposition the inclination angle between handle axis A and tool axis B to the second pre-defined angular in-use tool configuration (i.e., where handle axis A′ and tool axis B′ are at the Φ′ position depicted by phantom axes lines in FIG. 1A), which second in-use tool configuration will advantageously position the second edge 62b of the cutting blade 62 in an ergonomically advantageous second in-use tool position for use of the second edge 62b of the cutting blade 62 until it is dull, all without the need to remove and re-position the cutting blade 62 from the tool holding portion 60. The locking mechanism 72 will now be described below in more detail.

Experimentation by the inventor indicates that a hand-held utility knife, such as shown in the Figures, is most comfortable to a user and effective for cutting carpet and the like when the angle Φ between axis A and axis B is between about 125° degrees and 145°, and preferably about 135°. Similarly, the angle Φ defined between the axes A′ and B′ in the second in-use tool configuration of the handle portion 52 and the tool holder portion 60 is preferably between about 125° and 145°, and most preferably about 135°. The two angles Ω and Ω (seen in FIG. 1A) are preferably, but not essentially, equal in all cases.

Utility of the present invention derives primarily from the ability of the tool holding portion 60 to pivot around the rotational axis “C” relative to the handle portion 52 and to lock such rotation at two or more defined operative in-use tool configurations having inclination angles Φ and Φ′, as generally described above. The two or more locked in-use tool configurations are defined, at least in part, with reference to the ability to use both edges 62a and 62b of a tool element without the need to remove and re-position the cutting blade 62 in the tool holding position 60. While there are many ways to facilitate such pivotal movement and locking of the tool holding portion 60 relative to the handle portion 52, the preferred embodiment of doing so will now be described in more detail with a reference to the accompanying figures.

In the embodiment illustrated, the handle portion 52 optionally comprises two shell portions: a first handle portion 57 and a second handle portion section 59 that are operatively coupled together to define the interior cavity of the handle portion 52.

In the embodiment illustrated, the tool holding portion 60 optionally comprises two shell portions: a first tool holding portion 46 and a second tool holding portion 48 that are operatively coupled together to define an interior cavity of the tool holding portion 60.

Each of the first 57 and second 59 handle portions have an inwardly directed respective boss portion 57a and 59a, which boss portions 57a and 59a (best seen in FIG. 5) each present a cylindrical outer wall surface 57b and 59b, respectively, which outer wall surfaces 57b and 59b are sized and otherwise dimensioned for rotational mating with complimentary cylindrical inner wall portions 46b and 48b formed on respective boss portions 46a and 48a of the tool holding portion 60. With this arrangement, the handle boss portions 57a and 59a and the tool holder boss portions 46a and 48a interfit one within the other to act as a rotary bearing to permit relative rotation of the handle portion 52 and the tool holder portion 60 about the pivot longitudinal axis C.

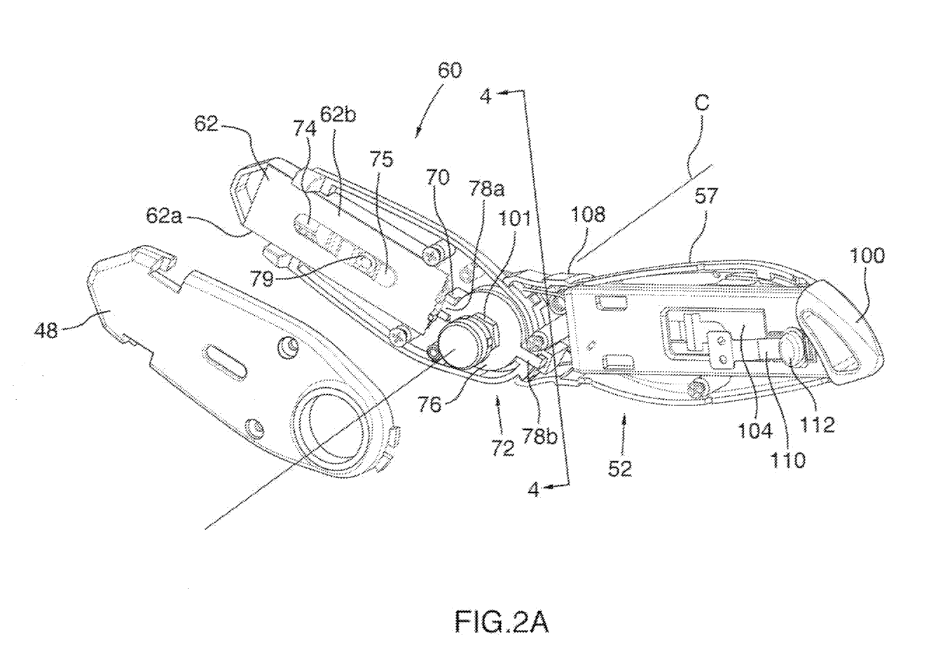

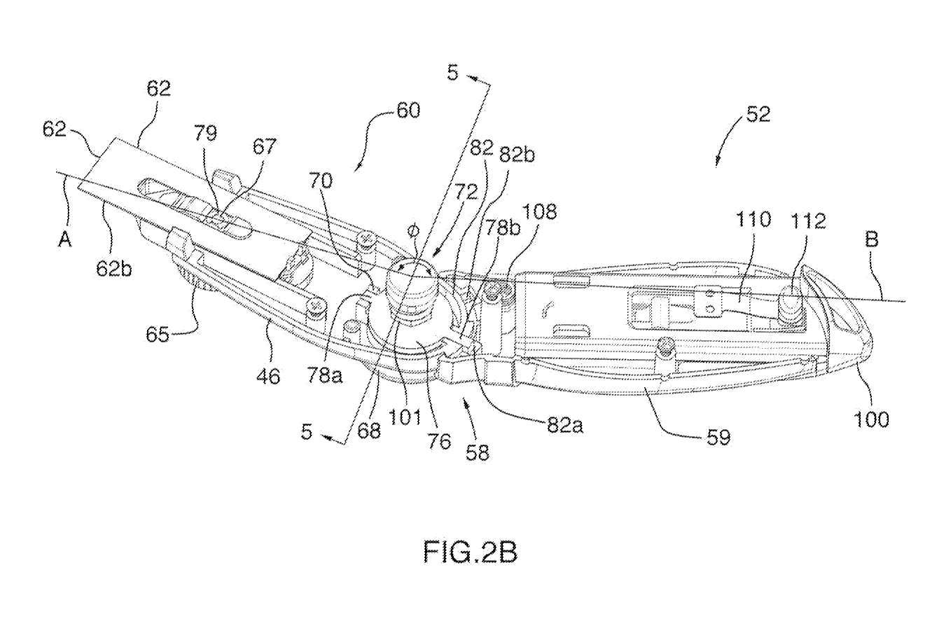

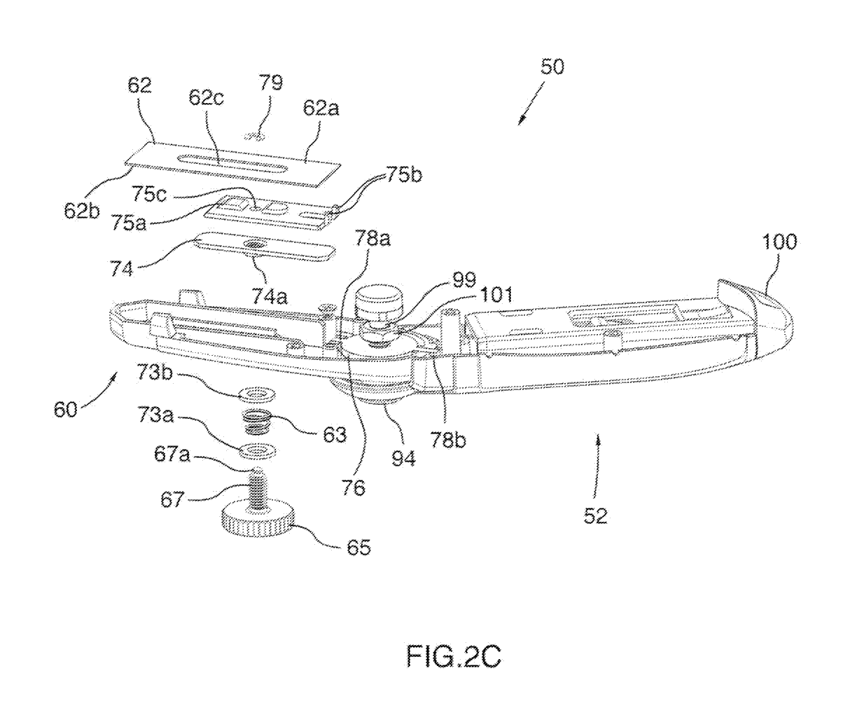

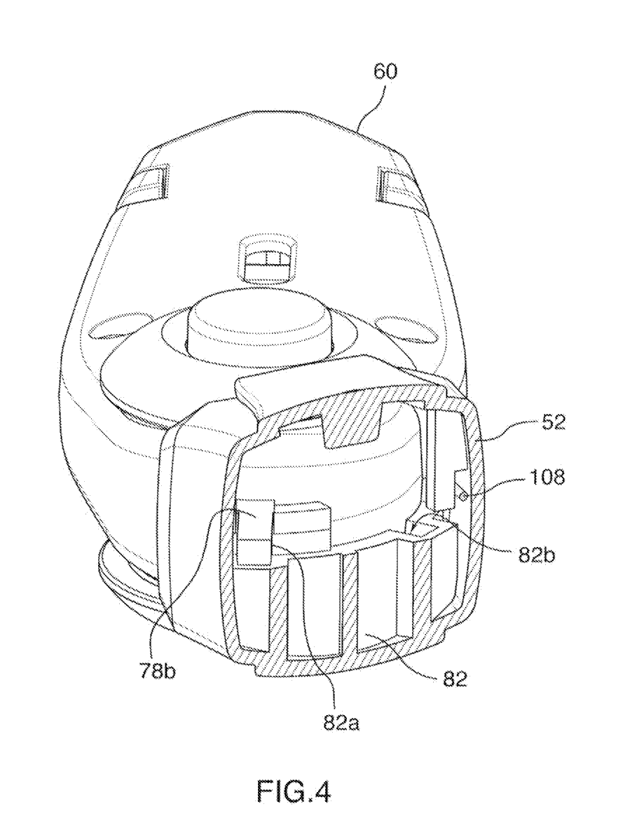

As previously mentioned and best seen in FIGS. 2A, 2B, 4, and 5, the present invention further comprises a locking mechanism 72 that is operatively interconnected between the proximal end 68 of the tool holding portion 60 and the proximal end 58 of the handle portion 52 to control pivotal movement of the handle portion 52 relative to the tool holding portion 60. When the locking mechanism 72 is engaged, the tool holding portion 60 is locked against rotation relative to the handle portion 52 about the rotational axis C, regardless of rotational forces acting on the hand tool 50 under normal operating conditions. Such locking provides for safe use of the hand tool 50.

The locking mechanism 72 may be vary considerably from the mechanism shown in the Figures, as the mechanism shown is but one of many types of locking mechanisms that could be used herein. Accordingly, the scope of the invention is not to be limited by specifics of the preferred locking mechanism illustrated. The locking mechanism 72 illustrated preferably includes a locking disc 76 having a central axis aligned with the rotational axis C, with the disc 76 being rigidly mounted on axle shaft 99 between shoulder 99a and lock nut 101. The axle shaft 99 has a larger diameter portion 99b extending above the level of the shoulder 99a (as seen in FIG. 5), the outer diameter of which portion 99b slidingly fits within the a mounting aperture 57c centrally formed within an internal annular flange 57d formed on the interior of the boss portion 57a of the first handle portion 57 for sliding motion along the rotational axis C in both directions as indicated by double-headed arrow F (shown in FIGS. 3B and 5) between two limit configurations. The first limit configuration (shown in the Figures and best seen in FIG. 5) is defined by the upper surface of the locking disc 76 hitting a first (upper as seen in FIG. 5) stop surface 46c on the first tool holding portion 46. The second limit configuration (not shown in the Figures) is defined by the lower surface of the locking disc 76 hitting a second (lower as seen in FIG. 5) stop surface 48c of the second tool holding portion 48. The axle shaft 99 is biased upwardly to the first limit configuration as shown in FIG. 5 by means of a coil spring 53 encircling the larger diameter portion 99b and extending under compression between an end cap 94 rigidly affixed to the free end of the larger diameter portion 99b and the internal annular flange 57d.

The locking disc 76 preferably also includes at least two locking arms 78a and 78b that extend radially outwardly in opposed relation and in transverse relationship to the rotational axis C. The first locking arm 78a engages and is held at all times within a retaining pocket 70 of complimentary cross-section formed upon mating of the first tool holding portion 46 and the second tool holding portion 48 when they are coupled together to form the tool holding portion 60. The retaining pocket 70 has sufficient height to accommodate full travel of the locking disc 78 in both directions of the double headed arrow F between the first (i.e., locked) and second (i.e., unlocked) limit configurations, while at the same time holding the first locking arm 78a in the retaining pocket 70 against rotation relative to the locking disc 76. In this manner, the tool holding portion 60 moves in unison with movement of the locking disc 76. In contrast, the second locking arm 78b is free to rotate, relative to the handle portion 52, only when the locking disc 76 is removed from the first limit configuration (which first limit configuration is shown in the Figures and is best seen in FIG. 5). In the first limit configuration of the locking disc 76, the second locking arm 78b engages a selected one of two receiving sockets 82a and 82b formed in an arcuate kneewall 82 inwardly curving around and positioned near the proximal end 58 of the first handle portion 57 (as best seen in FIG. 2B). The arc defined by the arcuate kneewall 82 is also preferably centered on the rotational axis C, so as to be substantially concentric with the circumference of the locking disc 76. The receiving sockets 82a and 82b are radially positioned in the arcuate kneewall 82 to coincided with alignment of handle axis A and tool axis B at the angles Φ and Φ′ discussed above. Accordingly, when the second locking arm 78b engages receiving socket 82a, the inclination angle between handle axis A and tool axis B is equal to Φ. Moreover, when the second locking arm 78b engages receiving socket 82b (not shown), the inclination angle between handle axis A and tool axis B is equal to Φ′.

When it is desired to unlock and change the relative position of the tool holding portion 60 relative to the handle portion 52 (such as, for example, when the user wishes to use the opposite other one of the cutting edges 62a 62b, the locking disc 76 can be moved by the user from the first (locked) configuration to the second (unlocked) configuration by the user pushing downwardly (as seen in FIG. 5) on the end cap 94. This downward pressure by a user causes an intentional force to act counter to the biasing force exerted by the coil spring 53 towards the locked configuration. If the user biasing force is greater than that of the safety coil spring 53, the locking disc 76 is translated along longitudinal axis C in a direction to cause the second locking arm 78b to disengage from the receiving socket 82a or 82b of the arcuate kneewall 82 in which it was previously held—that is the second locking arm 78b is translated along longitudinal axis C a sufficient distance so as to clear the top edge (as seen in FIG. 2A) of the arcuate kneewall 82, thereby disengaging the respective receiving socket 82a, 82b in which it was hitherto engaged. In this disengaged second (unlocked) configuration, the second locking arm 78b is free to rotate together with the tool holding portion 60 (to which it is rotationally keyed, as described above, by first locking arm 78a held in retaining pocket (70) relative to the handle portion 52 about longitudinal axis C between the pre-determined positions defined by receiving sockets 82a and 82b. When the user releases the end cap 94, the biasing force of the coil spring 53 will cause the attached second locking arm 78b to lockingly re-engage with either of receiving sockets 82a, 82b, over which it has been rotationally aligned. It the second locking arm 78b is not aligned with either of the receiving sockets 82a or 82b at the time of such release, it will make spring biased contact with the upper edge of the arcuate kneewall 82, but remain in an unlocked configuration. Further rotation of the tool holding portion 60 relative to the handle portion 52 will cause the upper edge of the arcuate kneewall 82 to act as a camming surface, until such time as alignment of the second locking arm 78b with one of the receiving sockets 82a or 82b is achieved, whereat the coil spring 53 will automatically cause the second locking arm 78b to lockingly re-engage with the respective socket, so as to allow the locking disc 76 to again achieve its first (locked) configuration, whereat further rotation of the tool holding portion 60 relative to the handle portion about longitudinal axis C is prevented.

The cutting blade 62 is releasably held within a cavity defined within the tool holding portion 60 so as to be slidable along the tool axis B between a retracted storage configuration as depicted in FIG. 1A) and an extended in-use blade configuration as depicted in FIG. 1B. FIG. 2C and FIG. 3B illustrate an exploded view which illustrates an exemplary mechanism by which the cutting blade 62 or a similar flat tool element may be operatively mounted on the tool holding portion 60. According to the preferred embodiment illustrated, the cutting blade 62 is operatively mounted on the tool holding portion 60 so as to be selectively slidable in both directions along the tool axis B by a variable pressure mounting assembly which preferably, but optionally, comprises a rotatable knurled thumb wheel 65 mounted on a threaded control shall 67, together with a coil spring 63, a set of friction washers 73a and 73b, a tool element guide plate 74, a tool element carriage 75, and a locking C-clip washer 79. The mounting assembly 61 operatively couples the tool element 62 to the tool holding portion 60 by controlling frictional forces between the coupling assembly 61 and the tool holding portion 60. The thumb wheel 65 is connected to the threaded shaft 67. In order to control the frictional forces between the coupling assembly 61 and the tool holding portion 60, the coupling assembly requires a mating portion into which the threaded shaft 67 is threaded. In the embodiment illustrated, the tool element guide plate 74 and the tool element carriage 75 have threaded sockets 74a and 75c, respectively, corresponding to female threaded sockets that both mate with the threaded shaft 67. The tool holding portion 60 includes a tool holding portion channel 71 through which the threaded shaft 67 extends in transverse relation to mate with the tool element guide plate 74 and the tool element carriage 75. In other words, the thumb wheel 65 is arranged such that it is on the exterior of the tool holding portion 60 and such that the threaded shaft 67 connected thereto extends through the tool holding portion channel 71. As the thumb wheel 65 is rotated in a clockwise direction, the threaded shaft 67 is further threaded into the mating threaded sockets of the tool element guide plate 74 and the tool element carriage 75. As the threaded shaft 67 is further threaded into the tool element guide plate 74 and the tool element carriage 75, the distance between the tool element guide plate 74 and the tool holding portion 60 is decreased and thus the frictional forces between the tool holding portion 60 and the tool element guide plate 74 are increased. Accordingly, when the thumb wheel 73 is rotated to such an extent that the frictional forces acting between the tool holding portion 60 and the tool element guide plate 74 are greater than the amount of transverse force acting on the thumb wheel 73 during normal operation, the frictional forces are sufficiently strong enough to hold the cutting blade 62 in a selectively fixed configuration. In order to prevent the thumb wheel 65 and threaded shaft 67 from becoming locked in position, the spring 63 and washer 73a are positioned around threaded shaft 67 so as to be on the exterior of the tool holding portion 60. Washer 73b is positioned around the threaded shaft 67 in the interior of the tool holding portion 60, between the tool holding portion 60 and the tool element guide plate 74. The tool element guide plate 74 and the tool element carriage 75 are operatively coupled by virtue of the threaded shaft 67 being threaded through mating female threaded sockets 74a and 75c in each of the tool element guide plate 74 and the tool element carriage 75. The tool element carriage 75 has a raised terminal ramp portion 75a adjacent a leading edge and a pair of raised tangs 75b adjacent the opposite trailing edge of the carriage, which together act to hold the cutting blade 62 in position relative to axis B, and thus carry the cutting blade 62 with it between the extended in-use blade configuration and the retracted blade storage configuration of the cutting blade 62, as the entire coupling assembly 61 traverses the housing channel 71 during blade adjustment by a user. In the preferred embodiment illustrated, and as best seen in FIG. 2C, the ramp portion 75a engages with a channel 62c formed in the tool element 62. FIG. 2C also illustrates the tang portions 75b,75b as extending in a direction perpendicular to the length of the tool element 62 (i.e., transverse to tool holder axis b), such that the tool element 62 abuts the pair of end tang portions 75b,75b when the tool element 62 is positioned against and aligned with the tool element guide plate 74. The cutting blade 62 is aligned with the tool element guide plate 74, such that a portion of the threaded shaft 67 extending through the mating female threaded socket in the tool element guide plate 74 also extends through the channel 62a. The C-clip washer 79 conventionally engages in frictional relation a circumferential channel 67a formed in the free end 67b of the threaded shaft 67 extending through the channel 62a.

Embodiments of the invention such as that illustrated, may optionally, but need not, include a tool element storage cartridge 100 as illustrated in FIGS. 2A, 2B, 3A, and 3B. The tool element storage cartridge 100 carries extra tool elements 104 which may be interchanged as necessary with the tool element 62 that is mounted within the tool holding portion 60. The tool element storage cartridge 100 has a cartridge spring clip 102 that applies a normal force on any extra tool elements 104 that are inserted into the tool element storage cartridge 100. The cartridge spring clip 102 is biased so as to prevent the extra tool elements 104 from inadvertently rattling while stored within the handle portion 52, or falling out of the tool element cartridge 100 when it is removed from the handle portion 52. The tool element storage cartridge 100 is preferably slidably insertable into the handle portion 52 at its distal end 56, into an internal cavity defined within the body of the handle portion 52. The handle portion 52 also preferably, but not necessarily, provides an eject torsion spring 108 operatively attached to an interior wall of the proximal end 58 of the handle portion 52. The eject torsion spring 108 is biased so as to apply force against the tool element cartridge 100 parallel to the handle axis A and towards the proximal end 58 of the handle portion 52, thereby to assist in ejection of the storage cartridge 100 when access thereto is required by a user. To prevent the unintentional ejection of the tool element cartridge 100 from the cavity defined by the handle portion 52, the tool element cartridge 100 preferably further includes a spring clip release lever 110 that is outwardly biased by its geometry and material selection in a direction perpendicular to the handle axis A. The spring clip release lever 110 further includes a cartridge release button 112 positioned adjacent to its proximal end, which button 112 contacts, under said outward biasing, the interior wall of the cavity defined by the handle portion 52 as the tool element cartridge 100 is translated into the internal cavity defined within the body of the handle portion 52 along the handle axis A in the direction from the distal end 56 towards the proximal end 58 of the handle portion 52. Accordingly, when the tool element cartridge 100 is fully inserted into the handle cavity, the button 112 protrudes through a complimentary aperture (not shown) formed through the sidewall of the handle portion 52 adjacent to the proximal end 58 of the handle portion 52, thereby to frictionally said aperture to hold the cartridge 100 against further axial sliding. When the release button 112 is depressed, the release lever 110 is lowered such that the release button 112 no longer engages the aforesaid aperture in the wall of the handle portion 52 which, in turn, allows the tool element cartridge 100 to be removed from the interior cavity defined by the handle portion 52.

A softer material layer, such as rubber or plastic, and preferably being less slippery than that of the handle portion 52, may also be attached to the exterior of the handle portion 52 so as to create a handle portion grip 120 around which users may more comfortably hold the hand held cutting tool 50. As illustrated in FIGS. 1A and 1B, this material may be ergonomically designed for better comfort and safety.

Numerous other options and variations are also possible. For example, while cutting blades having substantially straight cutting edges 80a and 80b are illustrated in the Figures, it will be appreciated that various other tool elements may be substituted therefore, including, without limitation, those tool elements known to have been previously used as a component of the well-known Swiss Army Knife™. Moreover, the preferred angles Φ and Φ′ at which the tool axis B intersects with the handle axis A may be multiplied and selectively varied based on the intended performance of the specific tool element. The tool element need not be retractable within the tool holder; indeed, the tool element need not even be removable from the tool holder, as the present invention in its simplest form may be used with hand tools whose tool elements are not replaceable.

I claim:

1. A hand held cutting tool for use with a cutting blade having two opposed parallel cutting edges, said tool comprising:
a) a handle portion having a distal end and a proximal end with a longitudinal handle axis extending therebetween;
b) a tool holding portion having a distal end and a proximal end with a longitudinal tool axis extending therebetween, said tool holding portion being adapted to hold said cutting blade in an in-use blade configuration with said two parallel cutting edges extending in substantially parallel relation to said tool axis from said distal end of the tool holding portion;
c) the tool holding portion being mounted adjacent its proximal end on the proximal end of the handle portion for pivotal movement of the tool holding portion and the handle portion relative to each other around a rotational axis which intersects and is transverse to both the handle axis and the tool axis between first and second in-use tool configurations which are mirror images of one another and at which first and second in-use tool configurations the inclination angle between the tool axis and the handle axis equals angle Φ, but in an opposite rotational direction; and,
d) a locking mechanism interconnected between the handle portion and the tool holding portion to selectively lock the tool holding portion relative to the handle portion at each of said first and second in-use tool configurations, thereby to provide for use of respective ones of said two opposed parallel cutting edges of the cutting blade without removal and re-positioning of the cutting blade in the tool holding position.

2. A hand held cutting tool according to claim 1, wherein angle Φ is between 125-140 degrees.

3. A hand held cutting tool according to claim 2, wherein angle Φ is 135 degrees.

4. A hand held cutting tool according to claim 3, wherein the cutting blade is operatively mounted on the tool holding portion so as to be selectively slidable along the tool axis between said in-use blade configuration and a retracted storage blade configuration in which the cutting blade is positioned within a cavity formed in the tool holding portion.

5. A hand held cutting tool according to claim 4, wherein the cutting blade is selectively lockable at least at said in-use blade configuration by means of a variable pressure coupling assembly.

6. A hand held cutting tool according to claim 5, wherein the cutting blade is selectively lockable at least at said in-use blade configuration and said storage configuration by means of said variable pressure coupling assembly.

7. A hand held cutting tool according to claim 6, wherein the two opposed parallel cutting edges are each serrated.

8. A hand held cutting tool according to claim 7, wherein the locking mechanism comprises a locking disc having a central axis aligned with the rotational axis, with a first and a second locking arm extending radially outwardly from the locking disc, said first locking arm being held fast at all times against relative rotation in a retaining pocket formed in one of said tool holding portion and said handle portion, with the second one of said locking arms be selectively free for rotation relative to the other of the tool holding portion and the handle portion when the locking mechanism is moved from a first locked configuration to a second unlocked configuration.

9. A hand held cutting tool according to claim 8, wherein said movement of the locking mechanism from said first locked configuration to said second unlocked configuration involves movement of the locking disc along the rotational axis.

10. A hand held cutting tool according to claim 9, wherein the locking mechanism is spring biased towards the locked configuration.

11. A hand held cutting tool according to claim 10, wherein, in the first locked configuration, the second locking arm engages and is held fast against rotation relative to the other of the tool holding portion and the handle portion in a selected one of two receiving sockets positioned in an arcuate kneewall formed on said other portion, the arc of which kneewall being centered on said rotational axis.

12. A hand held cutting tool according to claim 11, wherein, in the first locked configuration, the second locking arm engages and is held fast against rotation relative to the other of the tool holding portion and the handle portion in the first receiving socket, thereby locking the tool holding portion relative to the handle portion in said first in-use configuration, whereat the angle between the tool axis and the handle axis equals angle Φ in a first rotational direction.

13. A hand held cutting tool according to claim 12, wherein, in the first locked configuration, the second locking arm engages and is held fast against rotation relative to the other of the tool holding portion and the handle portion in the second receiving socket, thereby locking the tool holding portion relative to the handle portion in said second in-use tool configuration, whereat the angle between the tool axis and the handle axis equals angle Φ in a second rotational direction.

14. A hand held cutting tool according to claim 3, wherein the locking mechanism comprises a locking disc having a central axis aligned with the rotational axis, with a first and a second locking arm extending radially outwardly from the locking disc, said first locking arm being held fast at all times against relative rotation in a retaining pocket formed in one of said tool holding portion and said handle portion, with the second one of said locking arms be selectively free for rotation relative to the other of the tool holding portion and the handle portion when the locking mechanism is moved from a first locked configuration to a second unlocked configuration.

15. A hand held cutting tool according to claim 14, wherein said movement of the locking mechanism from said first locked configuration to said second unlocked configuration involves movement of the locking disc along the rotational axis.

16. A hand held cutting tool according to claim 15, wherein the locking mechanism is spring biased towards the locked configuration.

17. A hand held cutting tool according to claim 16, wherein, in the first locked configuration, the second locking arm engages and is held fast against rotation relative to the other of the tool holding portion and the handle portion in a selected one of two receiving sockets positioned in an arcuate kneewall formed on said other portion, the arc of which kneewall being centered on said rotational axis.

18. A hand held cutting tool according to claim 17, wherein, in the first locked configuration, the second locking arm engages and is held fast against rotation relative to the other of the tool holding portion and the handle portion in the first receiving socket, thereby locking the tool holding portion relative to the handle portion in said first in-use tool configuration, whereat the angle between the tool axis and the handle axis equals angle Φ in a first rotational direction.

19. A hand held cutting tool according to claim 18, wherein, in the first locked configuration, the second locking arm engages and is held fast against rotation relative to the other of the tool holding portion and the handle portion in the second receiving socket, thereby locking the tool holding portion relative to the handle portion in said second in-use tool configuration, whereat the angle between the tool axis and the handle axis equals angle Φ in a second rotational direction.

20. A hand held cutting tool according to claim 19, wherein a storage cartridge mounted within the handle portion is adapted to store spare cutting blades.
